(19) United States
(12) Patent Application Publication
(10) Pub. No.: US 2005/0218271 A1
(43) Pub. Date: Oct. 6, 2005

(54) Mouse pad

(76) Inventor: You-seok Jang, Seoul (KR)

Correspondence Address: GREENBLUM & BERNSTEIN, P.L.C., 1950 ROLAND CLARKE PLACE, RESTON, VA, 20191, US

(21) Appl. No.: 10/510,241

(22) PCT Filed: Apr. 15, 2003
(86) PCT No.: PCT/KR03/00761

§ 371 Date: Oct. 14, 2004

(30) Foreign Application Priority Data
Apr. 15, 2002 (KR) 20-2002-0011289

(51) Int. Cl. B68G 5/00

(52) U.S. Cl. 248/118

(57) ABSTRACT

Disclosed is a mouse pad. The present invention includes a pad part having a flat plate shape wherein the pad part has a mouse put thereon to drive and a wrist support part having a wrist support cushion installed to support a user's wrist, wherein the pad part and the wrist support part are separated from each other, wherein the pad part is detachably coupled with the wrist support part to enable a revolving operation, and wherein a tilt angle adjusting means for adjusting a tilt angle of the pad part is installed under the pad part. Accordingly, the present invention facilitates to adjust the tilt angle of the mouse pad, thereby enabling to enhance user's convenience.

### TECHNICAL FIELD

The present invention relates to a mouse pad, and more particularly, to a mouse pad having a structure such as a wrist-supporting cushion and the like to improve user's convenience, in which a pad part of the mouse pad where a mouse is put thereon is detachable from another part, i.e. a part having the cushion established thereon, as well as an angle of inclination thereof is adjustable.

### BACKGROUND ART

Generally, a mouse is a device for inputting various kinds of information such as menu selection, execution, and the like on a program, and is classified into a ball mouse using a rubber ball and an optical sensor mouse using light according to operating systems.

The ball mouse follows a scheme of moving a cursor position on a screen in accordance with a motion of a ball built in a mouse body, while the optical sensor mouse follows another scheme of moving a cursor position on a screen in accordance with a position of a light radiating inside a mouse. And, a precision of the optical sensor mouse is superior to that of the ball mouse, whereby the optical sensor mouse is mainly used in graphic works such as CAD, etc.

Such a mouse uses a plate-like mouse pad put on a flat place such as a desk, a table, and the like in general. Since there is no element supporting a user's wrist when the mouse is used, a pain is caused on the wrist of the user, ex. a graphic designer using a computer for many hours.

Accordingly, as shown in FIG. 1, a mouse pad having a wrist support cushion 2 fixed to an end of a flat pad part 1 has been developed. When a user uses the mouse, a user's wrist is naturally put on the wrist support cushion 2 to reduce a force applied to the wrist.

However, the above-explained mouse pad according to a related art includes the pad part 1, on which the mouse rolls, and the wrist support cushion 2 which is built in one body with the pad part 1 on the same line, whereby the cushion fails to secure an optimal support angle of the user's wrist.

Namely, in spite of different body structures, habits, user environments, and the like of the various users making use of the mouse pad, the cushion of the mouse pad always provides the user's wrist with the uniform support angle.

Moreover, when the user needs no wrist support cushion, the cushion is in the way of operating the mouse.

### DISCLOSURE OF THE INVENTION

Accordingly, the present invention is directed to a mouse pad that substantially obviates one or more of the problems due to limitations and disadvantages of the related art.

In a mouse pad having a wrist support, an object of the present invention is to provide a mouse pad including a flat pad part, over which the mouse rolls, having a predetermined tilt angle for a part at which a cushion is established.

Another object of the present invention is to provide a mouse pad including a pad part independent from another part having a cushion established thereon to be detachable from the part having the cushion established thereon.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a mouse pad according to the present invention includes a pad part having a flat plate shape, the pad part having a mouse put thereon to drive and a wrist support part having a wrist support cushion installed to support a user's wrist, wherein the pad part and the wrist support part are separated from each other, wherein the pad part is detachably coupled with the wrist support part to enable a revolving operation, and wherein a tilt angle adjusting means for adjusting a tilt angle of the pad part is installed under the pad part.

Preferably, a rotational shaft is built in one body along one side edge of the pad part and wherein a coupling groove having the rotational shaft inserted therein for assembly is built in one body of one side edge of the wrist support part.

Preferably, a coupling boss part having a coupling recess inside is formed at each end of the one side edge of the wrist support part, and a rotational pin inserted in the corresponding coupling recess to enable a revolving operation is formed at each end of the one side edge of the pad part to correspond to the coupling recess of the coupling boss part.

More preferably, at least one of the rotational pins of the pad part is installed to move in a lateral-direction of the pad part.

Preferably, a plurality of coupling holders having coupling grooves respectively provided by two confronting support pieces are formed along one side edge of the wrist support part, plurality of coupling recesses aligning with the coupling holders are formed along one side edge of the pad part, a rotational shaft part is formed to traverse the coupling recesses, and the rotational shaft part is coupled with the coupling grooves of the coupling holders of the wrist support part to enable a revolving operation.

Preferably, the tilt angle adjusting means includes a plurality of coupling bosses formed vertically on a lower surface of the pad part and a plurality of tilt angle adjusting bolts screwed to the coupling bosses, respectively, wherein the tilt angle of the pad part is adjusted by controlling a coupling amount of the tilt angle adjusting bolts.

Preferably, the tilt angle adjusting means includes a pair of support pieces installed on a lower surface of the pad part to confront each other, a support member coupled between the support pieces to revolve, and a stopper restricting a revolution of the support member when the support member has revolved by a predetermined angle.

Preferably, the tilt angle adjusting means includes an extension part extending from one side edge of the wrist support part to the pad part, a plurality of holding grooves on an upper surface of the extension part to leave a predetermined interval from each other, and a ‘U’ type support installed to revolve at a lower surface of the pad part to be caught on one of the holding grooves for support.

Preferably, the tilt angle adjusting means includes a plurality of fixing protrusions on a lower surface of the pad part to leave a predetermined interval from each other and a circular bar type support member having a fixing recess on its circumference wherein the fixing recess is coupled with the corresponding fixing, protrusion.

Preferably, the tilt angle adjusting means includes a plurality of ring shaped protruding rims protruding from a lower surface of the pad part and a rod type support member having a plurality of protrusion bars on one lateral side of the rod type support member wherein the protrusion bars are inserted in the ring-shaped protruding rims, respectively.

More preferably, the support member is made of a soft rubber.

More preferably, each vertical cross-section of the fixing protrusions and recess has a shape selected from the group consisting of trapezoid, lozenge, circle, elliptical, curve, and a combination of the trapezoid, lozenge, circle, elliptical, and curve.

More preferably, the support member includes a plurality of fixing members formed on a portion contacted with a ground wherein the fixing members are made of a synthesized resin or rubber material.

More preferably, a cut-open portion is formed on one side end of the support member and a plurality of the protrusion bars are formed on a cut-open face of the cut-open portion.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a bird's-eye view of a mouse pad according to a related art;

FIG. 2 illustrates a bird's-eye view of a disassembled mouse pad according to a first embodiment of the present invention;

FIG. 3 illustrates a cross-sectional view of an exemplary use of the mouse pad according to the first embodiment of the present invention;

FIG. 4 illustrates a layout of a mouse pad according to a second embodiment of the present invention;

FIG. 5 illustrates a layout of a mouse pad according to a third embodiment of the present invention;

FIG. 6 illustrates a cross-sectional view along a line I-I of the mouse pad in FIG. 5;

FIG. 7 illustrates a diagram of operating a mouse pad according to a fourth embodiment of the present invention;

FIG. 8 illustrates a diagram of operating a mouse pad according to a fifth embodiment of the present invention;

FIG. 9 illustrates a diagram of operating a mouse pad according to a sixth embodiment of the present invention;

FIG. 10 illustrates a support member of the sixth embodiment according to the present invention;

FIG. 11 illustrates a schematic diagram of a mouse pad according to a seventh embodiment of the present invention;

FIG. 12 illustrates a disassembled bird's-eye view of a mouse pad according to an eighth embodiment of the present invention;

FIG. 13 illustrates a bottom view of an eight embodiment according to the present invention;

FIG. 14 illustrates an operational view of the eighth embodiment of the present invention;

FIG. 15 illustrates a vertical cross-sectional view of a different support member of a mouse pad according to a ninth embodiment of the present invention; and

FIG. 16 illustrates an exemplary operational diagram of adjusting an angle of the mouse pad according to the eighth embodiment of the present invention using the support member of the ninth embodiment of the present invention.

### BEST MODE FOR CARRYING OUT THE INVENTION

Reference will now be made in detail to the preferred embodiments of the present invention, examples of which are illustrated in the accompanying drawings.

### First Embodiment

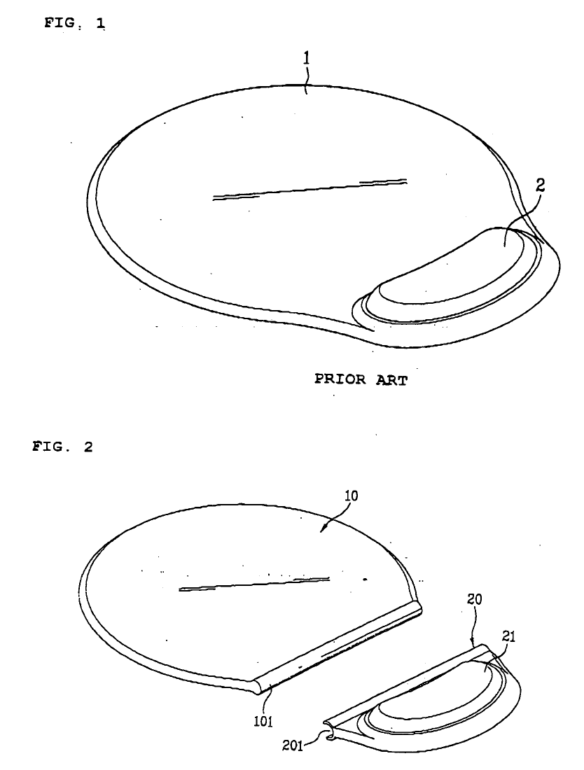

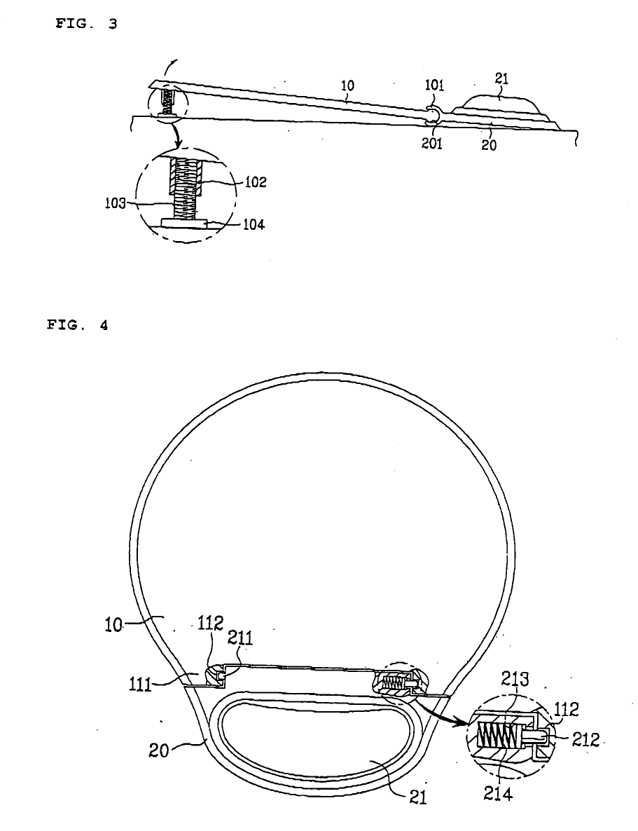

FIG. 2 and FIG. 3 illustrate a mouse pad according to a first embodiment of the present invention. A mouse pad, as shown in FIG. 2 and FIG. 3, includes a pad part 10 having a flat plate shape on which a mouse (not shown in the drawings) is put on to operate and a wrist support part 20 separated from the pad part 10 to be detachably coupled with an edge of a rear end of the pad part 10 to turn around.

A wrist support cushion 21 made of a soft material is installed at the wrist support part 20 to support a user's wrist.

For coupling the wrist support part 20 and the pad part 10 with each other, a rotational shaft 101 is built in one body along the edge of the rear end of the pad part 10 that will be coupled with the wrist support part 20, and a coupling groove 201 is built in one body of the wrist support part 20 to have the rotational shaft 101 of the pad part 10 inserted therein for assembly.

Therefore, once one end of the rotational shaft 101 of the pad part 10 is aligned with one end of the coupling groove 201 of the wrist support part 20 to push in a lateral direction, the rotational shaft 101 is inserted into the coupling groove 201 for assembly.

Meanwhile, the mouse pad according to the present invention includes a tilt angle adjusting means to adjust a tilt angle of the pad part 10 against the wrist support part 20. A plurality of coupling bosses 102 are installed at a front bottom of the pad part 10, and a tilt angle adjusting bolt 103, which is made of a soft rubber or resin and has a disc type support body 104 to prevent a slip, is screwed to a lower end of each of the coupling bosses 102 for assembly.

Therefore, a user releases or fastens the tilt angle adjusting bolt 103 to adjust a coupling degree of the tilt angle adjusting bolt 103 against the corresponding coupling boss 102, thereby enabling to adjust a tilt angle of the pad part 10 freely.

Besides, the pad part 10 and the wrist support part 20 of the mouse pad according to the present invention can be assembled detachably in a certain way different from the above-described embodiment of the present invention as well.

### Second Embodiment

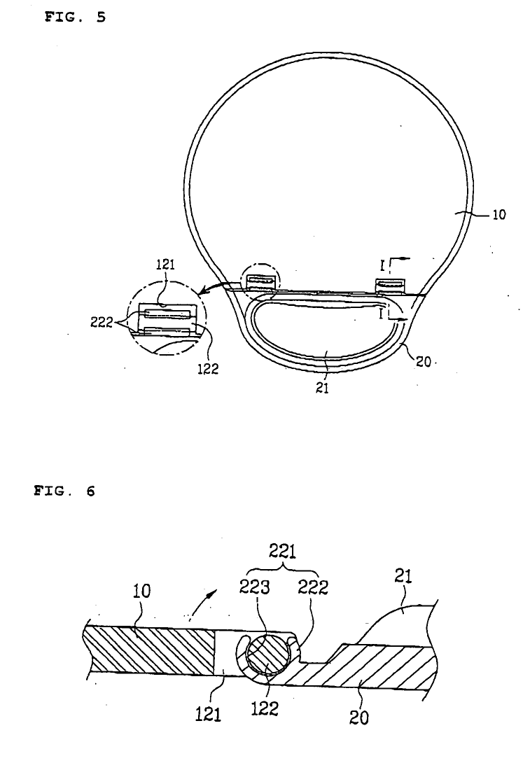

FIG. 4 illustrates a layout of a mouse pad according to a second embodiment of the present invention. A mouse pad, as shown in FIG. 4, includes a coupling boss part 111 having a coupling recess 112 formed inward in one body at each end of a front edge of a wrist support part 20 and first and second rotational pins 211 and 212 protruding outward from both ends of a rear edge of a pad part 10, respectively. The first and second rotational pins 211 and 212 are inserted into the coupling recesses 112 of the coupling boss parts 111, respectively to have the pad part 10 be assembled with the wrist support part 20 to revolve.

In this case, the second rotational pin 212 is installed to move in a lateral direction of the pad part 10. A recess 213 is formed at an edge of the pad part having the second rotational pin 212 installed thereat, the second rotational pin 212 is installed at the recess 213 to move, and a compressive spring 214 is installed inside the recess 213 to support the second rotational pin 212 elastically.

Therefore, the first rotational pin 211 of the pad part 10 is inserted into the coupling recess 112 of the coupling boss part 111 of the wrist support part 20. While such a state is maintained, a force is applied to the second rotational pin 212 of the pad part 10 to align the second rotational pin 212 with a position of the coupling recess 112 of the other coupling boss part 111. Once the force applied to the second rotational pin 212 is released, the second rotational pin 212 is pushed outward by an elastic force of the compressive spring 214 to be inserted in the coupling recess 112 of the coupling boss part 111. Thus, the pad part 10 is assembled with the wrist support part 20 to enable a revolving operation.

### Third Embodiment

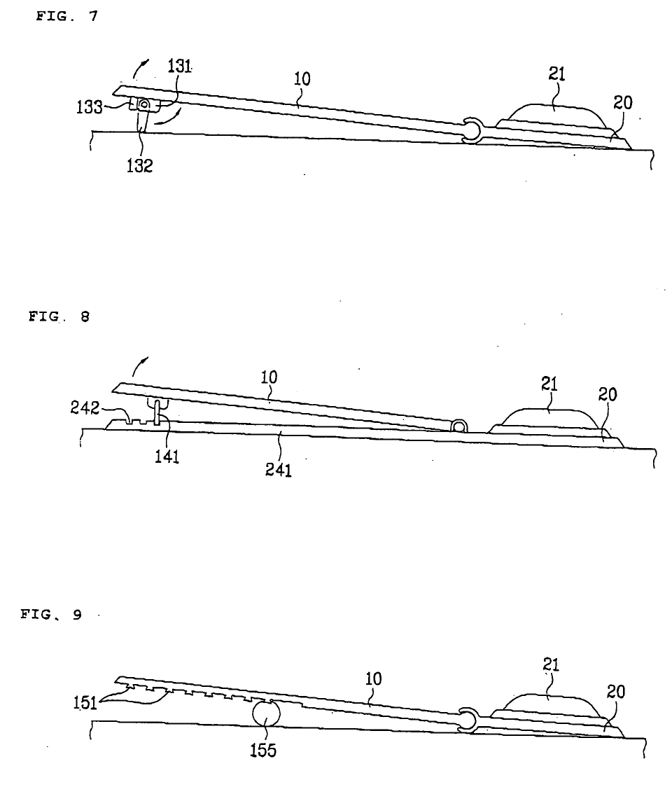

FIG. 5 and FIG. 6 illustrate a mouse pad according to a third embodiment of the present invention. A mouse pad, as shown in FIG. 5 and FIG. 6, includes at least one coupling holder 221, which has a coupling groove 223 provided by a pair of support pieces 222 confronting each other, at an edge of a front end of a wrist support part 20, at least one coupling recess 121 at an edge of a rear end of a pad part 10 to correspond to a position of the corresponding coupling holder 221, and a rotational shaft part 122 traversing the coupling recess 121. The rotational shaft part 122 of the pad part 10 is inserted in the coupling groove 223 of the coupling holder 221, whereby the pad part 10 is assembled with the wrist support part 20 to enable a revolving operation.

Meanwhile, even though various means for assembling the pad and wrist support parts 10 and 20 with each other are applied to the above-described embodiments of the mouse pads, these exemplary embodiments are intended to help understandings of the present invention only. In addition to the above-described embodiments of the present invention, all kinds of means for assembling the pad part 10 with the wrist support part 20 can be applied to the present invention.

For instance, a structural body such as a hinge is applied to coupling portions of the pad and wrist support parts 10 and 20 to assemble the pad part 10 with the wrist support part 20 for a revolving operation.

### Fourth Embodiment

FIG. 7 illustrates a diagram of operating a mouse pad according to a fourth embodiment of the present invention, in which another embodiment of a tilt angle adjusting means is shown. Referring to FIG. 7, a pair of support pieces 131 are installed at a front portion of a bottom of a pad part 10, a support member 132 is installed between the support pieces 131 to enable a revolving operation, and a stopper 133 is built in one body of a front of each of the support pins 131 to restrict a revolution of the support member 132. Thus, a tilt angle adjusting means constituted.

When a user wants to use the mouse pad without adjusting a tilt angle of the pad part 10, the support member 132 of the tilt angle adjusting means of the embodiment is folded to use. When the user wants to use the mouse pad by adjusting the tilt angle of the pad part 10, the support member 132 is revolved so that the pad part 10 has a predetermined tilt angle to a ground.

In accordance with the tilt angle adjusting means according to the embodiment of the present invention, the pad part 10 can be provided with a predetermined tilt angle by a simple operation of revolving the support member 132.

### Fifth Embodiment

FIG. 8 illustrates a diagram of operating a mouse pad according to a fifth embodiment of the present invention, proposing a tilt angle adjusting means having a different constitution based on a technical background of the fourth embodiment of the present invention.

In a tilt angle adjusting means according to the fifth embodiment of the present invention, an extension part 241 extending toward a pad part 10 is built in one body of a front end of a wrist support part 20, a plurality of holding grooves 242 are formed on the extension part 241 to leave a predetermined interval from each other, a ‘U’ type support 141 is installed on a bottom of the pad part 10 to revolve freely. A lower end of the support 141 is held to support by one of the holding grooves 242 of the extension part 241, thereby enabling to adjust a tilt angle of the pad part 10 variously.

In this case, each of the holding grooves 242 is preferably formed to have a triangle shape, i.e. a width of a lower end is greater than that of an upper end, so that the lower end of the support 141 having been inserted therein is not easily taken off. Yet, the width, as shown in FIG. 8, can be formed uniform. Furthermore, any kind of shape is within the technical scope of the present invention.

Hence, in the above-constituted tilt angle adjusting means, when a user wants to increase a tilt angle of the pad part 10, the support 141 is caught on the holding groove 242 closest to the front end of the wrist support part 20. If the user wants to decrease the tilt angle of the pad part 10, the support 141 is caught on the holding groove 242 farthest from the front end of the wrist support part 20 for use.

Meanwhile, the above-described tilt angle adjusting means has an exemplary purpose to help the understanding of the present invention. Besides, in addition to the above-described tilt angle adjusting means according to the embodiments of the present invention, any tilt angle adjusting means having various constitutions can be applied to the present invention.

Besides, if the user wants no wrist support cushion 21 installed at the wrist support part 20, the wrist support part 20 can be separated from the pad part 20 to use.

### Sixth Embodiment

FIG. 9 illustrates an operational diagram of a mouse pad according to a sixth embodiment of the present invention and FIG. 10 illustrates a support member 155 of the sixth embodiment according to the present invention, in which the support member 155 detachably slides beneath each portion of a pad part 10 to propose a technical background of adjusting a tilt angle of the mouse pad.

A tilt angle adjusting means according to the embodiment of the present invention includes a plurality of fixing protrusions 151, each of which has a triangle cross-section, formed on a bottom of a pad part 10 to leave a predetermined interval from each other and a circular bar type support member 155 coupled with one of the fixing protrusions 151.

The support member 155 includes a fixing groove 156 formed at one side of a circumference along a length direction to correspond to the fixing protrusions 151.

Hence, when a user wants to adjust a tilt angle, one end of the fixing groove 156 of the support member 155 is aligned with one end of the demanded one of the fixing protrusions 151 and is then pushed inward in a lateral direction. Thus, the fixing protrusion 151 is inserted in the fixing groove 156 of the support member 155, whereby the support member 155 is fixed to a lower portion of the pad part 10 so that the pad part 10 is provided with a demanded tilt angle to a ground.

In this case, it is preferable that the support member 155 is made of a soft rubber material, which prevents the support member 155 from slipping over the ground to secure a stable supporting power.

### Seventh Embodiment

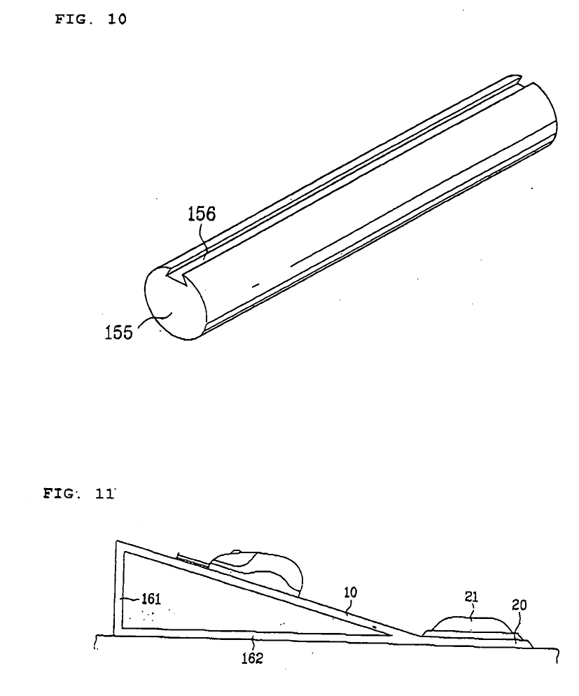

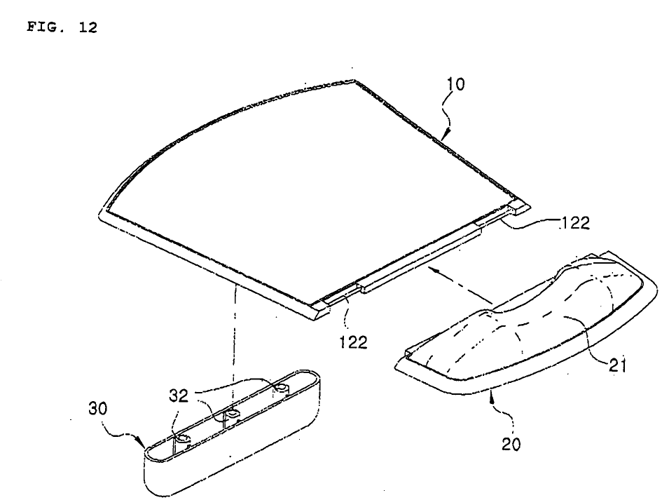

FIG. 11 illustrates a schematic diagram of a mouse pad according to a seventh embodiment of the present invention.

In this embodiment of the present invention, a pad part 10 and a wrist support part 20 are built in one body by injection molding or the like instead of being formed separately. Besides, the pad part 10 is formed to have a predetermined tilt angle by a vertical support part 161 and a horizontal support part 162 built in one body of one ends of the pad and wrist support parts 10 and 20, respectively.

In this case, the tilt angle of the pad part 10 provides an angle optimal to a human body by human engineering.

An empty space is formed below a lower part of the pad part 10 by the vertical and horizontal support parts 161 and 162, in which a user can store some goods such as scratch papers, ball point pens, and the like.

### Eighth Embodiment

FIGS. 12 to 14 illustrate-a disassembled bird's-eye view, a bottom view, and an operational state view of a mouse pad according to an eighth embodiment of the present invention, showing the further developed constitution and operational principle of a tilt angle adjusting means from those of the support member 155 and the like proposed by the foregoing sixth embodiment of the present invention.

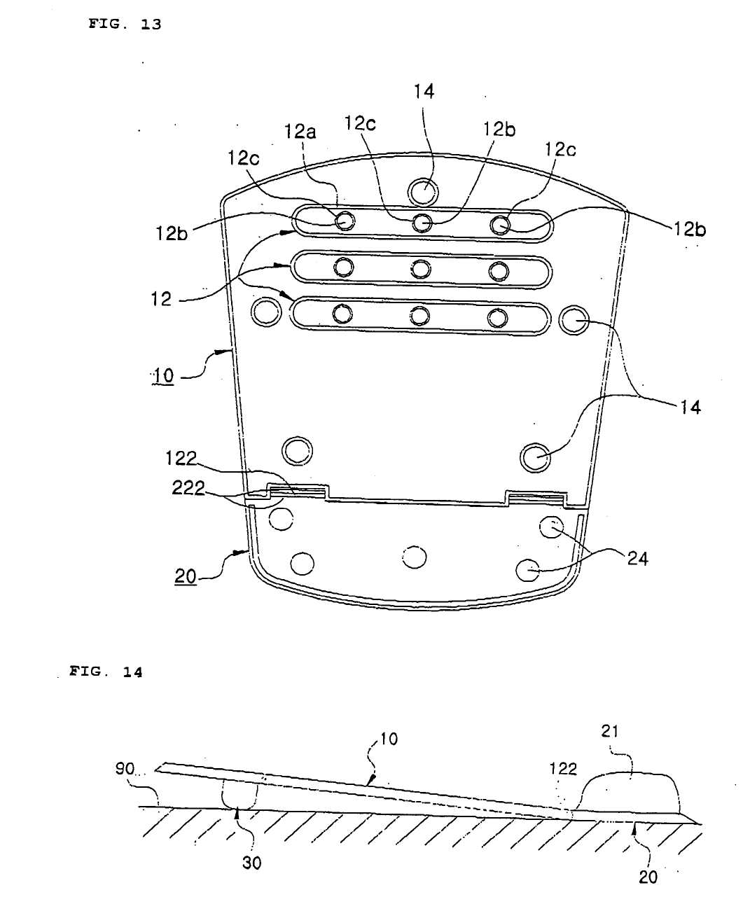

A tilt angle adjusting means according to the embodiment of the present invention, as shown in FIG. 13, includes a plurality of ring-shaped protruding rims 12c protruding downward from a bottom of a pad part 10 to leave a predetermined interval from each other. Three of the ring-shaped protruding rims 12c are formed beneath the bottom of the pad part 10 to leave the same interval from each other, and the middle one of the three ring-shaped protruding rims 12c is located at a center of the pad part 10. In this case, a protruding edge 12a embracing a plurality of the ring-shaped protruding rims 12c inside is formed to protrude downward to the same height of the ring-shaped protruding rims 12c. Thus, a protruding part 12 includes the protruding edge 12a and a plurality of the ring-shaped protruding rims 12c.

The above-constituted protruding edge 12a maintains to be contacted with a circumference of one lateral side of a support member 30, which will be explained later, according to the embodiment of the present invention, thereby enabling to play a role of dispersing a weight applied to the pad part 10 on the support member 30 completely.

Preferably, a plurality of the above-constituted protruding parts 12 are formed to leave the same interval from each other in a vertical direction of the pad part 10.

Moreover, an insertion hole 12b having a predetermined space inside is formed by the ring-shaped protruding rim 12c, and a protrusion bar 32 of a support member 30 that will be explained later is inserted in the insertion hole 12b for assembly.

Meanwhile, a support member 30 coupled with the pad part 10 detachably includes a plurality of protrusion bars 32 at one lateral side of the support member 30. Each of the protrusion bars 32 protrudes upward to be inserted in the corresponding insertion hole 12b.

Moreover, an inside of the support member 30, as shown in FIG. 12, is hollow, the above-constituted protrusion bar 32 protrudes upward, a bottom of the support member 30 is rounded to prevent a frictional noise with a ground.

In aspect of a coupling principle of the pad and wrist support parts 10 and 20, a support piece 222 at one lateral end of the wrist support part 20 is coupled with a rotational shaft part 122 at one lateral side of the pad part 10 to enable a revolving operation so as to have the same coupling constitution and operation principle of the foregoing third embodiment of the present invention. In this case, fixing members 14 and 24 made of a synthesized resin or rubber material having a great frictional coefficient are attached to bottoms of the pad and wrist support parts 10 and 20, respectively, thereby maximizing an adhesion to a ground.

Hence, in adjusting a user-demanding angle, as shown in FIG. 14, the protrusion bars 32 at the support member 30 are inserted in the insertion holes 12b of a plurality of the protruding parts 12 formed on the bottom of the pad part 10 in a vertical direction for assembly, thereby enabling to adjust the angle of the pad part 10 from a ground 90 more easily.

### Ninth Embodiment

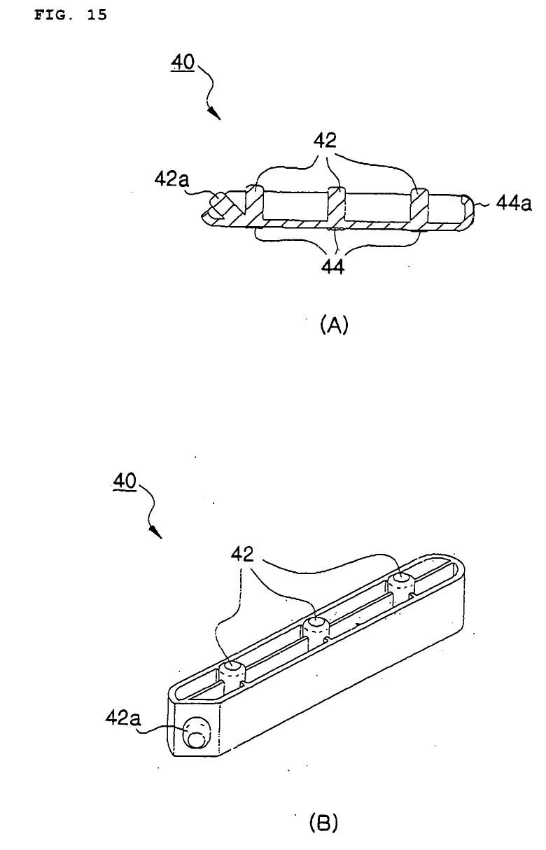

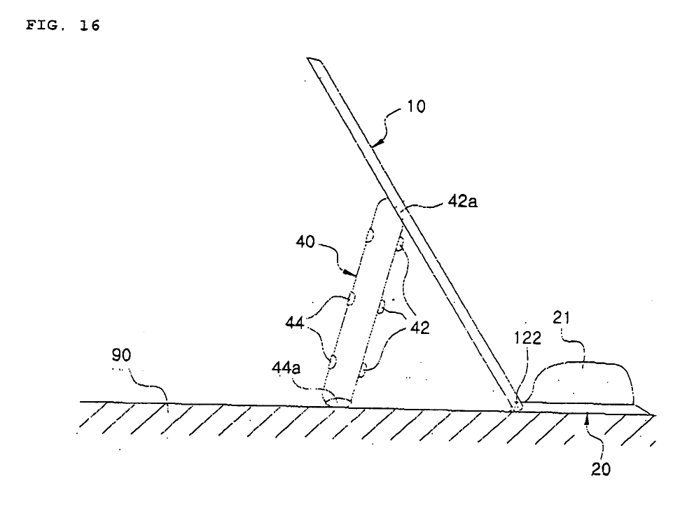

FIG. 15 illustrates a vertical cross-sectional view of a support member 40, which is different from that 30 of the eighth embodiment, of a mouse pad according to a ninth embodiment of the present invention, and FIG. 16 illustrates an exemplary operational diagram of adjusting an angle of the mouse pad according to the eighth embodiment of the present invention using the support member 40 of the ninth embodiment of the present invention.

A support member 40 according to the ninth embodiment of the present invention is constituted in a way different from that of the support member 30 proposed by the foregoing eighth embodiment of the present invention. When the support member 40 according to the ninth embodiment of the present invention, a pad part 80 enables to maintain a greater angle from a ground surface 90, thereby enabling to keep a paper, a book, or the like between the pad and wrist support parts 80 and 20.

In detail, the support member 40, as shown in ‘A’ and ‘B’ of FIG. 15, is characterized in that the above-constituted protrusion bars 42a protrude from a cut-open part (no reference numeral) having one lateral end cut by a predetermined angle and a cut-open face (no reference numeral) of the cut-open part (no reference numeral) and that fixing members 44 and 44a are attached to the other side end and a bottom face. Hence, the support member 40 according to the ninth embodiment of the present invention has the same constitution of the support member 30 proposed by the foregoing eighth embodiment of the present invention except those structural characteristics.

The angle adjustment, as shown in FIG. 16, of the pad part 80 by the support member 40 having such structural characteristics is achieved in a manner that the protrusion bar 42a protruding from the cut-open face (no reference numeral) is inserted in an insertion hole 12b on the bottom of the pad part 10 for assembly. Thus, the pad part 10 enables to maintain a great angle from the ground 90, and can be used as a stand for a book and the like.

### INDUSTRIAL APPLICABILITY

Accordingly, the mouse pad according to the present invention enables to provide a user's wrist with a more stable support angle to reduce a fatigue applied to the wrist since the pad part having the mouse driven thereon has a predetermined tilt angle.

Moreover, in the constitution of the mouse pad that the pad part and the wrist support part are separated from each other, the pad part is separated to use if a user needs no wrist support cushion to use. Therefore, the user's convenience is enhanced.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. A mouse pad comprising:
a pad part having a flat plate shape, the pad part having a mouse put thereon to drive; and
a wrist support part having a wrist support cushion installed to support a user's wrist,
wherein the pad part and the wrist support part are separated from each other, wherein the pad part is detachably coupled with the wrist support part to enable a revolving operation, and wherein a tilt angle adjusting means for adjusting a tilt angle of the pad part is installed under the pad part.

2. The mouse pad of claim 1, wherein a rotational shaft is built in one body along one side edge of the pad part and wherein a coupling groove having the rotational shaft inserted therein for assembly is built in one body of one side edge of the wrist support part.

3. The mouse pad of claim 1, wherein a coupling boss part having a coupling recess inside is formed at each end of the one side edge of the wrist support part and wherein a rotational pin inserted in the corresponding coupling recess to enable a revolving operation is formed at each end of the one side edge of the pad part to correspond to the coupling recess of the coupling boss part.

4. The mouse pad of claim 3, wherein at least one of the rotational pins of the pad part is installed to move in a lateral direction of the pad part.

5. The mouse pad of claim 1, wherein a plurality of coupling holders having coupling grooves respectively provided by two confronting support pieces are formed along one side edge of the wrist support part, wherein a plurality of coupling recesses aligning with the coupling holders are formed along one side edge of the pad part, wherein a rotational shaft part is formed to traverse the coupling recesses, and wherein the rotational shaft part is coupled with the coupling grooves of the coupling holders of the wrist support part to enable a revolving operation.

6. The mouse pad of claim 1, the tilt angle adjusting means comprising:
a plurality of coupling bosses formed vertically on a lower surface of the pad part; and
a plurality of tilt angle adjusting bolts screwed to the coupling bosses, respectively,
wherein the tilt angle of the pad part is adjusted by controlling a coupling amount of the tilt angle adjusting bolts.

7. The mouse pad of claim 1, the tilt angle adjusting means comprising:
a pair of support pieces installed on a lower surface of the pad part to confront each other;
a support member coupled between the support pieces to revolve; and
a stopper restricting a revolution of the support member when the support member has revolved by a predetermined angle.

8. The mouse pad of claim 1, the tilt angle adjusting means comprising:
an extension part extending form one side edge of the wrist support part to the pad part;
a plurality of holding grooves on an upper surface of the extension part to leave a predetermined interval from each other; and
a “U” type support installed to revolve at a lower surface of the pad part to be caught on one of the holding grooves for support.

9. The mouse pad of claim 1, the tilt angle adjusting means comprising:
a plurality of fixing protrusions on a lower surface of the pad part to leave a predetermined interval from each other; and
a circular bar type support member having a fixing recess on its circumference wherein the fixing recess is coupled with the corresponding fixing protrusion.

10. The mouse pad of claim 1, the tilt angle adjusting means comprising:
a plurality of ring shaped protruding rims protruding from a lower surface of the pad part; and
a rod type support member having a plurality of protrusion bars on one lateral side of the rod type support member wherein the protrusion bars are inserted in the ring-shaped protruding rims, respectively.

11. The mouse pad of claim 9, wherein the support member is made of a soft rubber.

12. The mouse pad of claim 9, wherein each vertical cross-section of the fixing protrusions and recess has a shape selected from the group consisting of trapezoid, lozenge, circle, elliptical, curve, and a combination of the trapezoid, lozenge, circle, elliptical, and curve.

13. The mouse pad of claim 10, the support member comprising a plurality of fixing members formed on a portion contracted with a ground wherein the fixing members are made of a synthesized resin or rubber material.

14. The mouse pad of claim 10, wherein a cut-open portion is formed on one side end of the support member and a plurality of the protrusion bars are formed on a cut-open face of the cut-open portion.

15. The mouse pad of claim 11, wherein each vertical cross-section of the fixing protrusions and recess has a shape selected from the group consisting of trapezoid, lozenge, circle, elliptical, curve, and a combination of the trapezoid, lozenge, circle, elliptical, and curve.

16. The mouse pad of claim 13, wherein a cut-open portion is formed on one side end of the support member and a plurality of the protrusion bars are formed on a cut-open face of the cut-open portion.
